(19) United States
(12) Patent Application Publication
(10) Pub. No.: US 2018/0159287 A1
(43) Pub. Date: Jun. 7, 2018

(54) MANUFACTURING METHOD OF A MODULAR CONNECTOR AND A LOCK-IN DEVICE THEREOF

(71) Applicant: YOU HUNG INTERNATIONAL CO., LTD., New Taipei City (TW)

(72) Inventor: TZU-RUNG TSAY, NEW TAIPEI CITY (TW)

(21) Appl. No.: 15/367,593

(22) Filed: Dec. 2, 2016

(51) Int. Cl. H01R 43/20; H01R 13/639; H01R 24/64; H01R 43/027

(52) U.S. Cl. CPC H01R 43/20; H01R 13/6397; H01R 43/027; H01R 24/64; H01R 13/6395

(57) ABSTRACT

A manufacturing method of a modular connector and a lock-in device thereof has the modular connector including an oblong hole at a rear end thereof to be filled with a flexible rubber body but left with an engaging hole in a middle section of the oblong hole, and the lock-in device including a through hole arranged aside which has a clip arranged on a periphery wall thereof with a protruding latch, so that when the modular connector is inserted into the through hole to a per-determined position, the latch would engage the engaging hole for positioning and fixing the engagement.

### BACKGROUND OF THE INVENTION

### 1. Field of the Invention

The present invention relates to a manufacturing method of a modular connector and a lock-in device thereof, particularly to one that has a protruding latch on the lock-in device engaging an engaging hole on the modular connector for locking up.

### 2. Description of the Related Art

Nowadays internet networks have been widely applied in information transfer. Such networks mainly rely on the Ethernet networks for rapid and stable transfer of information. Simply plugging in a cable connector into a port and the data and information are easily obtained. However, such technology allows unauthorized users to have access to the information and data easily, thus leaving uncertainties in information security.

There are various locks designed for such problem in the markets. For example, a hollow locker is engaged on a cable connector to restrict the accessibility of the information and the locker can only be unlocked by a key with specific designs. Thereby the information accessible via networks is secured. However, such design is merely an obvious theft-proof structure without extra enhancement of the locking status, which is desirable to be improved.

### SUMMARY OF THE INVENTION

A primary object of the present invention is to provide a manufacturing method of a modular connector and a lock-in device thereof that has a hidden structure to prevent from theft in order to further enhance information security.

To achieve the objects mentioned above, the present invention comprises steps as following.

a. providing a rigid modular connector formed by plastic materials and including a first surface and a second surface, said first surface having a plurality of evenly arranged fillisters at a front end thereof and a space arranged at a rear end thereof, wherein an oblong hole is arranged on the first surface perpendicularly connecting to the space;

b. providing a cable and a plurality of metal pieces, said metal pieces disposed in the fillisters individually and said cable exposing a plurality of wires with a pre-determined length to be inserted into the space of the modular connector, each disposed right under each fillister to be electrically connected to each metal piece;

c. providing a flexible rubber body filled in the space and extended to wrap up an end of the cable at a pre-determined length, wherein the rubber body is filled in the oblong hole and leaves an engaging hole perpendicularly arranged to the oblong hole in a middle section thereof, so as to form a cable connector; and

d. providing a locker including a through hole arranged aside for a cable connector to be plugged in or removed from and a flexible piece disposed on a periphery wall of the through hole, said flexible piece further including a protruding latch corresponding to a position of the engaging hole.

Whereby when the cable connector is inserted into the through hole of the locker to a pre-determined position, the protruding latch is engaging into the engaging hole for positioning.

Furthermore, a locker hole is arranged adjacent to the through hole and partially connected thereto via a connecting space. The locker further includes a closed extended end at a rear end thereof and a disposing space arranged adjacent to the locker hole with an engaging block disposed therein. In addition, the locker includes a vertical opening arranged at an opposite side of the flexible piece; the engaging block further has a block correspondingly arranged to the vertical opening to be displaced along the opening vertically.

With structures disclosed above, the present invention forms a hidden structure of theft prevention with the engaging hole of the modular connector and the protruding latch of the locker and further has an obvious theft-proof structure by the locker hole. With the two-stages theft-proof structure applied, the information security of network cables is undoubtedly assured.

### BRIEF DESCRIPTION OF THE DRAWINGS

FIG. 1 is a flow chart illustrating the manufacturing method of the present invention;

FIG. 2 is an exploded view of a modular connector, a cable and a plurality of metal pieces in the present invention;

FIG. 3 is a perspective view of the modular connector, the cable, the metal pieces and a rubber piece assembled in the present invention;

FIG. 4 is a perspective view of a cable connector and a locker in the present invention in a preferred embodiment;

FIG. 5 is a perspective view of the elements in FIG. 4 assembled;

FIG. 6 is a perspective view of FIG. 4 from another angle of view;

FIG. 7 is a perspective view of FIG. 5 from another angle of view;

FIG. 8 is a sectional view of the cable connector engaging the locker in the present invention illustrating a protruding latch engaging an engaging hole; and

FIG. 9 is a sectional view taken along line 9-9 in FIG. 8.

### DETAILED DESCRIPTION OF THE PREFERRED EMBODIMENT

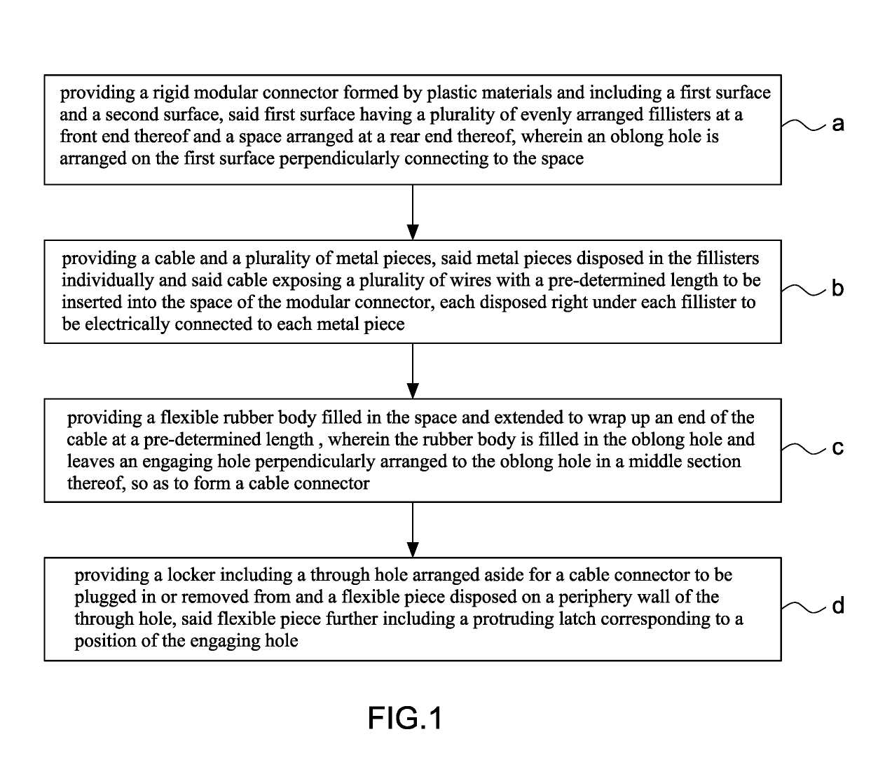

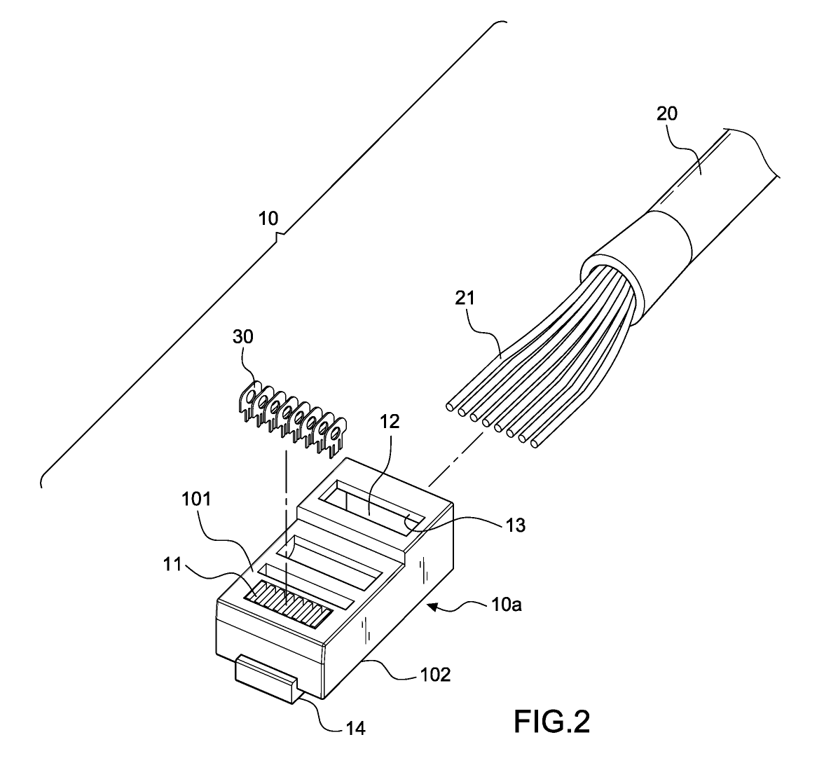

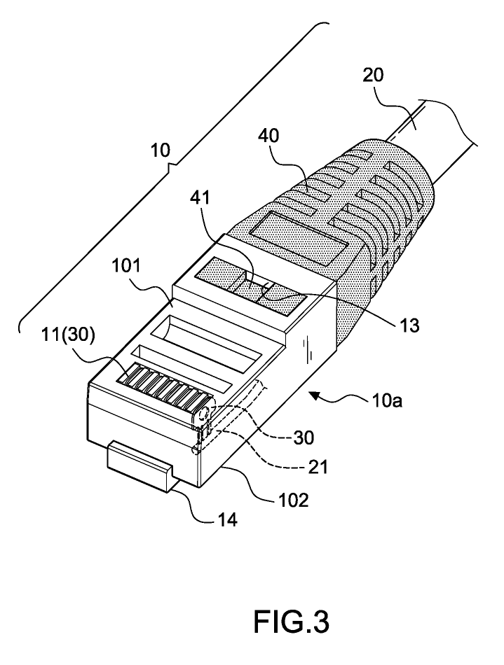

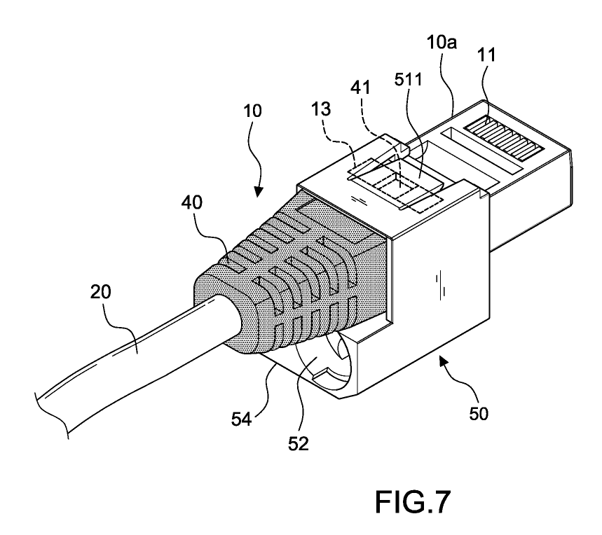

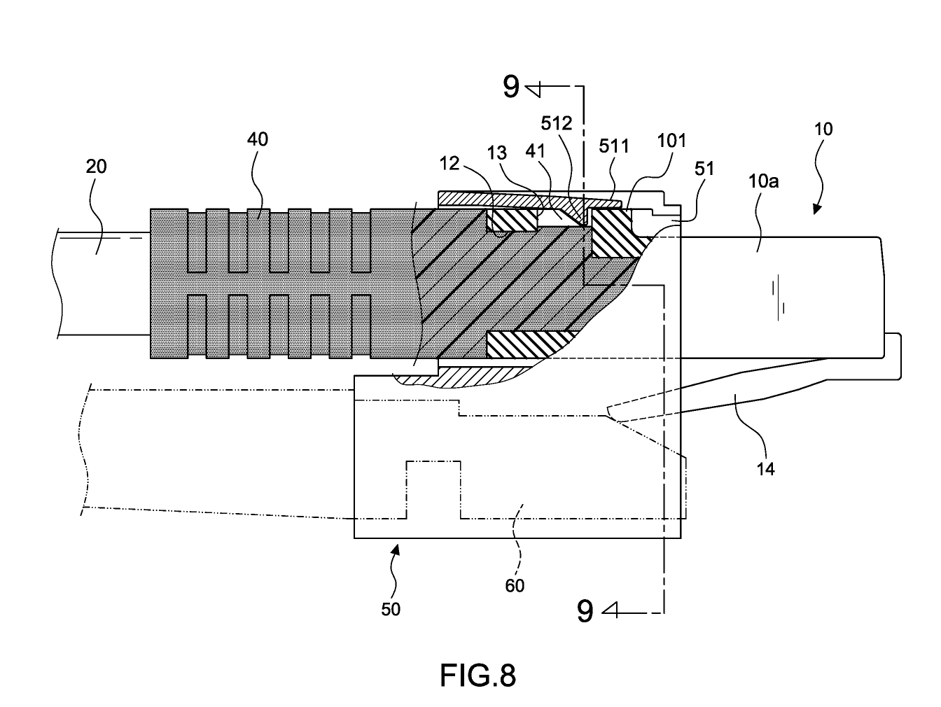

With reference to FIGS. 1-9, in a preferred embodiment, the present invention comprises steps as following.

Step a. providing a rigid modular connector 10a formed by plastic materials and including a first surface 101 and a second surface 102. The first surface 101 has a plurality of evenly arranged fillisters 11 at a front end thereof and a space 12 arranged at a rear end thereof. An oblong hole 13 is arranged on the first surface 101 perpendicularly connecting to the space 12. In this embodiment, the modular connector 10a is of the RJ45 standard with eight fillisters 11, and the second surface 102 has a clip 14 thereon.

Step b. providing a cable 20 and a plurality of metal pieces 30. The cable 20 has a plurality of wires 21 exposed with a pre-determined length at an end thereof to be inserted into the space 12 of the modular connector 10a. Each wire 21 is disposed right under a fillister 11 to be electrically connected to the metal piece 30 disposed therein. In this embodiment, there are eight wires 21 and eight metal pieces 30.

Step c. providing a flexible rubber body 40 filled in the space 12 and extended to wrap up an end of the cable 20 at a pre-determined length. The rubber body 40 is filled in the oblong hole 13 and leaves an engaging hole 41 perpendicularly arranged to the oblong hole 13 in a middle section thereof, so as to form a cable connector 10. The cable connector 10 has the same sizes as conventional RJ 45 connectors; therefore it is instantly applicable to products in the market. However, it is also distinguishable from the appearance since the cable connector 10 has the engaging hole 41 arranged on the first surface 101 of the rubber body 40.

Furthermore, the cable connector 10 can be correspondingly applied with a locker 50 as described in the following step.

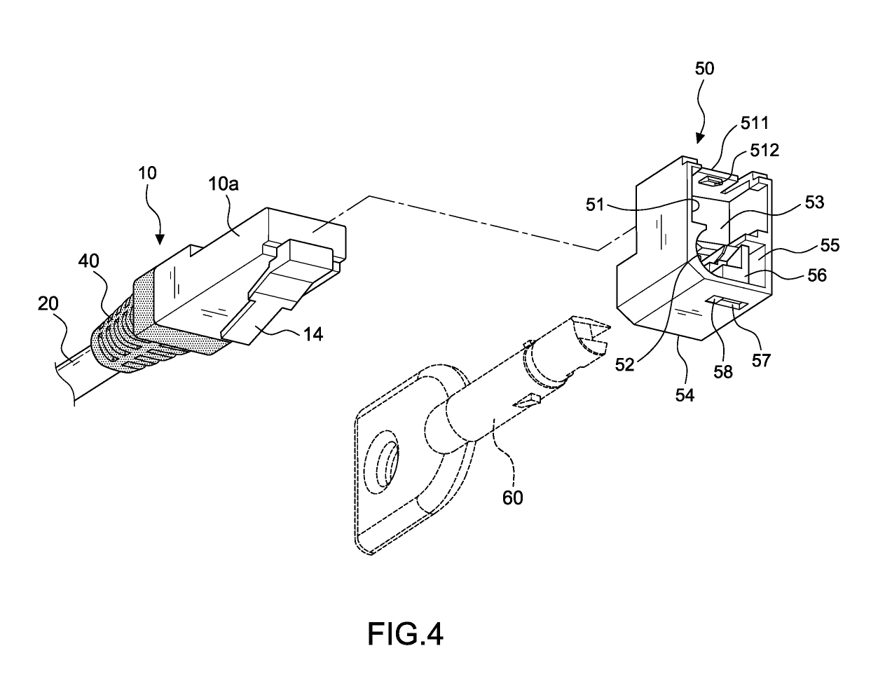

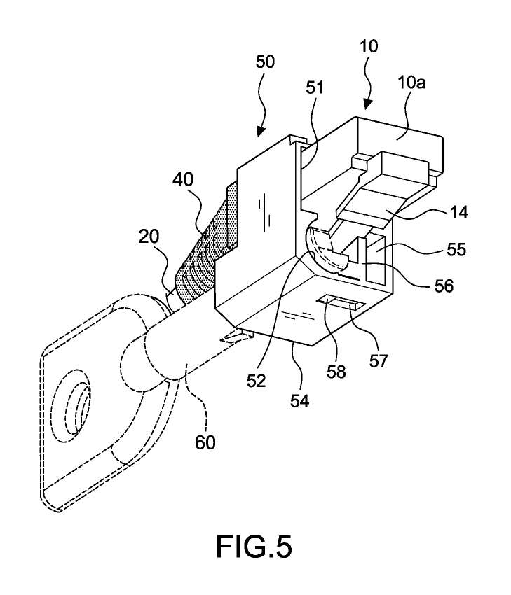

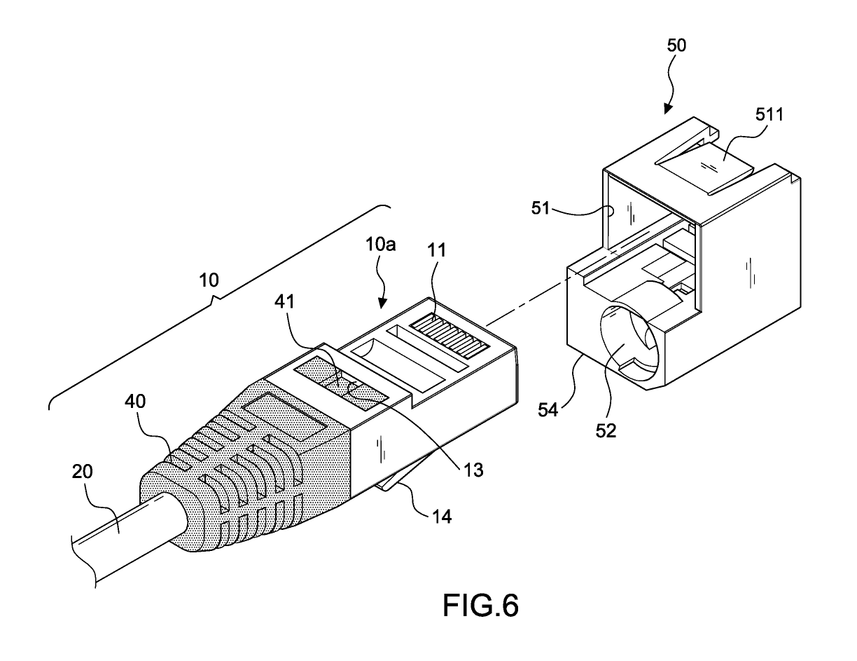

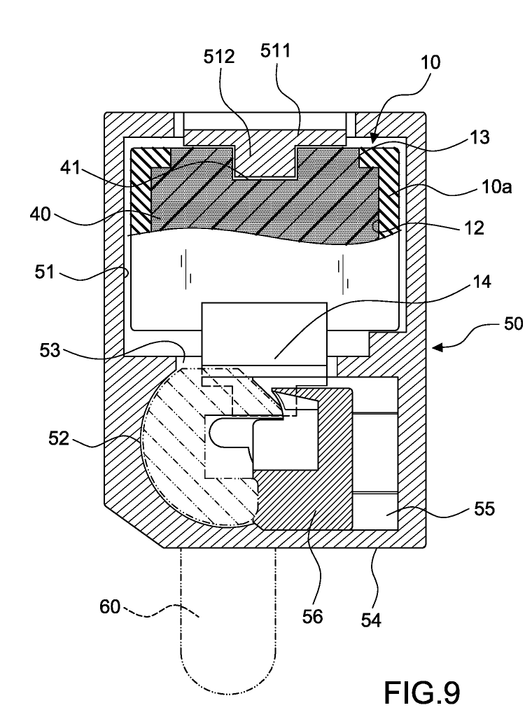

Step d. providing a locker 50 including a through hole 51 arranged aside for the cable connector 10 to be plugged in or removed from and a flexible piece 511 disposed on a periphery wall of the through hole 51. The flexible piece 511 further includes a protruding latch 512 corresponding to a position of the engaging hole 41 as shown in FIG. 6. In the embodiment, the locker 50 further has a locker hole 52 is arranged adjacent to the through hole 51 and partially connected thereto via a connecting space 53 as shown in FIG. 9; a closed extended end 54 is arranged at a rear end of the locker 50 and a disposing space 55 is arranged adjacent to the locker hole 52 with an engaging block 56 disposed therein as shown in FIGS. 4 and 5. In addition, the locker 50 further includes a vertical opening 57 arranged at an opposite side of the flexible piece 511 and the engaging block 56 further has a block 58 correspondingly arranged to the vertical opening 57 to be displaced along vertically, thereby the locker 50 can be unlocked by having a key 60 inserted into the locker hole 52 and turned for unlocking.

With structures disclosed above, when the cable connector 10 is inserted into the through hole 51 of the locker 50 to a pre-determined position, the protruding latch 512 engages into the engaging hole 41 on the locker 50 for positioning as illustrated in FIGS. 6-9. The design also forms a hidden structure that prevents theft by enhancing the locking status on the locker 50. After turning the key 60 for unlocking, a user has to pull up the protruding latch 512 slightly from the engaging hole 41 to safely remove the locker 50 from the cable connector 10. The present invention therefore ensures better information security for networking cables.

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. A manufacturing method of a modular connector and a lock-in device thereof, comprising:
a. providing a rigid modular connector formed by plastic materials and including a first surface and a second surface, said first surface having a plurality of evenly arranged fillisters at a front end thereof and a space arranged at a rear end thereof, wherein an oblong hole is arranged on the first surface perpendicularly connecting to the space;
b. providing a cable and a plurality of metal pieces, said metal pieces disposed in the fillisters individually and said cable exposing a plurality of wires with a pre-determined length to be inserted into the space of the modular connector, each disposed right under each fillister to be electrically connected to each metal piece;
c. providing a flexible rubber body filled in the space and extended to wrap up an end of the cable at a pre-determined length, wherein the rubber body is filled in the oblong hole and leaves an engaging hole perpendicularly arranged to the oblong hole in a middle section thereof, so as to form a cable connector; and
d. providing a locker including a through hole arranged aside for a cable connector to be plugged in or removed from and a flexible piece disposed on a periphery wall of the through hole, said flexible piece further including a protruding latch corresponding to a position of the engaging hole;
whereby when the cable connector is inserted into the through hole of the locker to a pre-determined position, the protruding latch engages into the engaging hole on the locker for positioning.

2. The manufacturing method of a modular connector and a lock-in device thereof as claimed in claim 1, wherein a locker hole is arranged adjacent to the through hole and partially connected thereto via a connecting space.

3. The manufacturing method of a modular connector and a lock-in device thereof as claimed in claim 2, wherein the locker further includes a closed extended end at a rear end thereof and a disposing space arranged adjacent to the locker hole with an engaging block disposed therein.

4. The manufacturing method of a modular connector and a lock-in device thereof as claimed in claim 3, wherein the locker further includes a vertical opening arranged at an opposite side of the flexible piece.

5. The manufacturing method of a modular connector and a lock-in device thereof as claimed in claim 4, wherein the engaging block further has a block correspondingly arranged to the vertical opening to be displaced along the opening vertically.
